(19) United States
(12) Patent Application Publication
(10) Pub. No.: US 2021/0067042 A1
(43) Pub. Date: Mar. 4, 2021

(54) MULTI-PHASE SWITCHED CAPACITOR POWER CONVERTER AND CONTROL METHOD THEREOF

(71) Applicant: uPI semiconductor corp., Zhubei City (TW)

(72) Inventors: Hsien-Cheng LIU, Zhubei City (TW); Chien-Fu CHEN, Zhubei City (TW)

(21) Appl. No.: 16/991,101

(22) Filed: Aug. 12, 2020

(30) Foreign Application Priority Data
Sep. 2, 2019 (TW) 108131505

(51) Int. Cl. H02M 3/158

(52) U.S. Cl. CPC H02M 3/1584; H02M 2003/1586

(57) ABSTRACT

A multi-phase switched capacitor power converter and a control method thereof are disclosed. The multi-phase switched capacitor power converter includes a first phase converting circuit and a second phase converting circuit. The first phase converting circuit and the second phase converting circuit include switches and a flying capacitor respectively. The switches are coupled in series and there are a first node and a second node between the switches. The flying capacitor is coupled to the first node and the second node. When the first phase converting circuit is in an operating mode and the second phase converting circuit is in a standby mode, the control method controls a part of the switches in the second phase converting circuit continuously conducted to charge the flying capacitor.

### BACKGROUND OF THE INVENTION

### 1. Field of the Invention

The invention relates to a multi-phase power converter; in particular, to a multi-phase switched capacitor power converter and a control method thereof.

### 2. Description of the Prior Art

In general, a multi-phase switched capacitor power converter includes a first phase converting circuit and a second phase converting circuit, and each phase converting circuit includes a plurality of switches coupled in series and a flying capacitor.

As shown in FIG. 1, before the time T1, the multi-phase switched capacitor power converter is lightly-loaded, the phase control signal STEP is at low-level, and the pulse width modulation signal PWM1 is enabled and the pulse width modulation signal PWM2 is disabled; at the time T1, the multi-phase switched capacitor power converter changes from light-load to heavy-load, the phase control signal STEP also changes from low-level to high-level, and the pulse width modulation signal PWM1 remains enabled, but the pulse width modulation signal PWM2 which was originally disabled becomes enabled.

However, during the phase converting process, the multi-phase switched capacitor power converter usually has no special mechanism to pre-charge the flying capacitor, resulting in the inrush current IOUT2 appeared on the first switch coupled to the input voltage in the second phase converting circuit at the time T1 and the first switch burns out, or the output voltage VOUT has peak fluctuations and becomes unstable, which seriously affects the performance of the multi-phase switched capacitor power converter and needs to be improved.

### SUMMARY OF THE INVENTION

Therefore, the invention provides a multi-phase switched capacitor power converter and a control method thereof to solve the above-mentioned problems of the prior arts.

A preferred embodiment of the invention is a control method for controlling a multi-phase switched capacitor power converter. In this embodiment, the multi-phase switched capacitor power converter includes a first phase converting circuit and a second phase converting circuit. The first phase converting circuit and the second phase converting circuit include a plurality of switches and a flying capacitor respectively. The switches are coupled in series and there are a first node and a second node between the switches. The flying capacitor is coupled to the first node and the second node. The control method includes: when the first phase converting circuit is in an operating mode and the second phase converting circuit is in a standby mode, controlling a part of the switches of the second phase converting circuit continuously conducted to charge the flying capacitor.

In an embodiment, the switches includes a first switch, a second switch, a third switch and a fourth switch coupled in series; the first node is located between the first switch and the second switch and the second node is located between the third switch and the fourth switch; the second switch and the fourth switch are continuously conducted when the second phase converting circuit is in the standby mode.

In an embodiment, when the multi-phase switched capacitor power converter is lightly-loaded, the first phase converting circuit is in the operating mode and the second phase converting circuit is in the standby mode.

In an embodiment, when the multi-phase switched capacitor power converter is heavily-loaded, the first phase converting circuit and the second phase converting circuit are both in the operating mode.

Another preferred embodiment of the invention is a multi-phase switched capacitor power converter. In this embodiment, the multi-phase switched capacitor power converter includes a first phase converting circuit, a second phase converting circuit and a controller. The second phase converting circuit includes a plurality of switches and a flying capacitor. The switches are coupled in series and there are a first node and a second node between the switches. The flying capacitor is coupled to the first node and the second node. The controller is coupled to the first phase converting circuit and the switches of the second phase converting circuit respectively. When the controller controls the first phase converting circuit in an operating mode and controls the second phase converting circuit in a standby mode, the controller controls a part of the switches of the second phase converting circuit continuously conducted to charge the flying capacitor.

In an embodiment, the multi-phase switched capacitor power converter further includes an output capacitor; when the second phase converting circuit is in the standby mode, the output capacitor and the flying capacitor are coupled in parallel.

In an embodiment, the switches of the second phase converting circuit includes a first switch, a second switch, a third switch and a fourth switch coupled in series; the first node is located between the first switch and the second switch and the second node is located between the third switch and the fourth switch.

In an embodiment, the second switch and the fourth switch are continuously conducted when the second phase converting circuit is in the standby mode.

In an embodiment, when the multi-phase switched capacitor power converter is lightly-loaded, the first phase converting circuit is in the operating mode and the second phase converting circuit is in the standby mode.

In an embodiment, when the multi-phase switched capacitor power converter is heavily-loaded, the first phase converting circuit and the second phase converting circuit are both in the operating mode.

Compared to the prior art, the multi-phase switched capacitor power converter and control method thereof in the invention can effectively avoid the inrush current appeared at the moment of phase conversion without causing the switch coupled to the input voltage to burn out and can maintain a stable output voltage without peak fluctuations to improve the performance of the multi-phase switched capacitor power converter.

The advantage and spirit of the invention may be understood by the following detailed descriptions together with the appended drawings.

### BRIEF DESCRIPTION OF THE APPENDED DRAWINGS

FIG. 1 illustrates a timing diagram of the multi-phase switched capacitor power converter having the surge current and the peak fluctuation of the output voltage at the time T1 in the prior art.

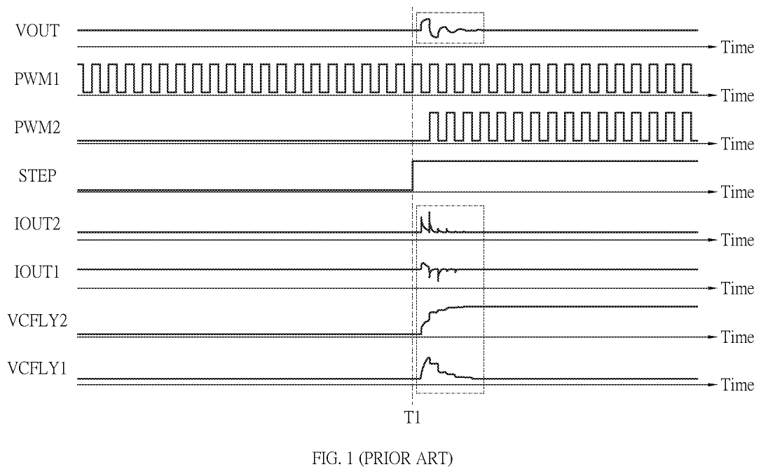

FIG. 2 illustrates a schematic diagram of the second switch and the fourth switch in the second phase converting circuit of the multi-phase switched capacitor power converter being conducted in the invention.

FIG. 3 illustrates a schematic diagram of the first switch and the third switch in the second phase converting circuit of the multi-phase switched capacitor power converter being conducted in the invention.

FIG. 4 illustrates a timing diagram of the multi-phase switched capacitor power converter without surge current and peak fluctuation of the output voltage at the times T1 and T2 in the invention.

FIG. 5 illustrates a flowchart of the multi-phase switched capacitor power converter control method in another embodiment of the invention.

### DETAILED DESCRIPTION OF THE INVENTION

Reference will now be made in detail to the exemplary embodiments, the same or similar reference numbers or components used in the drawings and the embodiments are used to represent the same or similar parts.

An embodiment of the invention is a multi-phase switched capacitor power converter. In this embodiment, the multi-phase switched capacitor power converter includes a plurality of phase converting circuits. Each phase converting circuit includes a first switch, a second switch, a third switch and a fourth switch coupled in series between an output voltage and a ground, and each phase converting circuit has an operating mode and a standby mode. The switches of each phase converting circuit can be transistors, such as metal-oxide-semiconductor field-effect transistors (MOSFETs), but not limited to this.

When the multi-phase switched capacitor power converter operates normally, regardless of whether the multi-phase switched capacitor power converter is lightly-loaded or heavily-loaded, at least one of the phase converting circuits is in the operating mode, and the remaining phase converting circuits are in the operating mode or the standby mode depending on the needs of the load.

It should be noted that in the multi-phase switched capacitor power converter of the invention, a part of the switches in the phase converting circuit in the standby mode will be still conducted, so that the flying capacitor and the output capacitor can be coupled in parallel to pre-charge the flying capacitor.

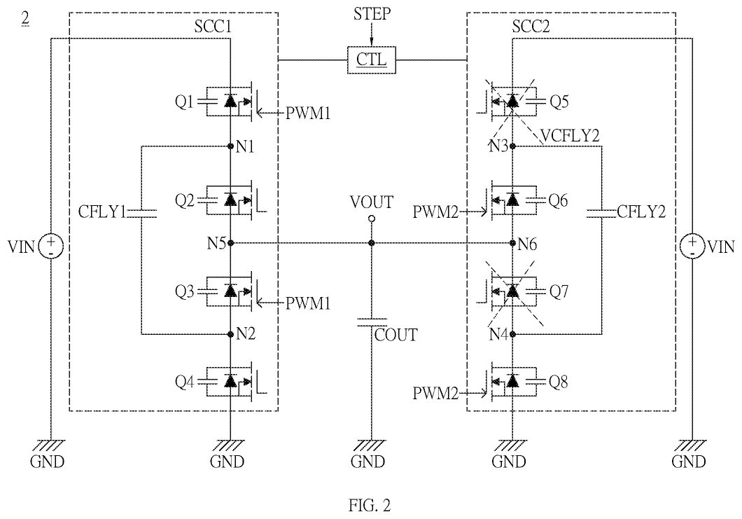

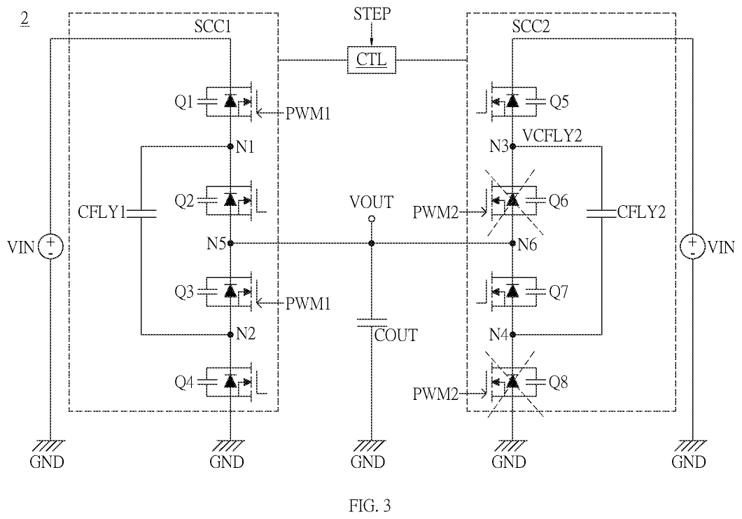

Please refer to FIG. 2 and FIG. 3. FIG. 2 shows a schematic diagram of the switches Q6 and Q8 in the second phase converting circuit SCC2 of the multi-phase switched capacitor power converter 2 being conducted; FIG. 3 shows a schematic diagram of the switches Q5 and Q7 in the second phase converting circuit SCC2 of the multi-phase switched capacitor power converter 2 being conducted.

As shown in FIG. 2, the multi-phase switched capacitor power converter 2 includes a first phase converting circuit SCC1, a second phase converting circuit SCC2, a controller CTL and an output capacitor COUT. The controller CTL is coupled to the first phase converting circuit SCC1 and the second phase converting circuit SCC2 respectively. The controller CTL provides pulse width modulation signals PWM1 and PWM2 to the first phase converting circuit SCC1 and the second phase converting circuit SCC2 respectively to control the switches Q1 to Q8 to control the first phase converting circuit SCC1 and the second phase converting circuit SCC2 in the operating mode or the standby mode. The output capacitor COUT is coupled to the first phase converting circuit SCC1, the second phase converting circuit SCC2 and the ground GND respectively.

The first phase converting circuit SCC1 includes a plurality of switches Q1 to Q4 and a flying capacitor CFLY1. The switches Q1 to Q4 are coupled in series between the input voltage VIN and the ground GND. One terminal of the flying capacitor CFLY1 is coupled to the node N1 between the switches Q1 and Q2 and the other terminal of the flying capacitor CFLY1 is coupled to the node N2 between the switches Q3 and Q4. The switches Q1 and Q3 are controlled by the pulse width modulation signal PWM1 for switching, and the switches Q2 and Q4 are complementarily switched with the switches Q1 and Q3.

The second phase converting circuit SCC2 includes a plurality of switches Q5 to Q8 and a flying capacitor CFLY2. The switches Q5 to Q8 are coupled in series between the input voltage VIN and the ground GND. One terminal of the flying capacitor CFLY2 is coupled to the node N3 between the switches Q5 and Q6 and the other terminal of the flying capacitor CFLY1 is coupled to the node N4 between the switches Q7 and Q8. The switches Q6 and Q8 are controlled by the pulse width modulation signal PWM2 for switching, and the switches Q5 and Q7 are complementarily switched with the switches Q6 and Q8.

One terminal of the output capacitor COUT is coupled to the nodes N5 and N6 and the other terminal of the output capacitor COUT is coupled to the ground GND. The node N5 is located between the switches Q2 and Q3 in the first phase converting circuit SCC1 and the node N6 is located between the switches Q6 and Q7 in the second phase converting circuit SCC2.

When the multi-phase switched capacitor power converter 2 is heavily-loaded, the controller CTL controls the first phase converting circuit SCC1 and the second phase converting circuit SCC2 in the operating mode according to the phase control signal STEP, but not limited to this; when the multi-phase switched capacitor power converter 2 is lightly-loaded, the controller CTL controls the first phase converting circuit SCC1 in the operating mode and the second phase converting circuit SCC2 in the standby mode according to the phase control signal STEP, but not limited to this. In this embodiment, when the multi-phase switched capacitor power converter 2 is heavily-loaded, the phase control signal STEP is at high-level; when the multi-phase switched capacitor power converter 2 is lightly-load, the phase control signal STEP is at low-level, but not limited to this.

According to the above, when the multi-phase switched capacitor power converter 2 changes from heavy-load to light-load, the controller CTL controls the first phase converting circuit SCC1 to maintain in the operating mode according to the phase control signal STEP, and controls the second phase converting circuit SCC2 to change from the operating mode to the standby mode. When the multi-phase switched capacitor power converter 2 changes from light-load to heavy-load, the controller CTL controls the first phase converting circuit SCC1 to maintain in the operating mode according to the phase control signal STEP, and controls the second phase converting circuit SCC2 to change from the standby mode to the operating mode.

In this embodiment, when the second phase converting circuit SCC2 is in the standby mode, the controller CTL controls a part of the switches of the second phase converting circuit SCC2 to be continuously conducted according to the phase control signal STEP, so that the flying capacitor CFLY2 of the second phase converting circuit SCC2 is pre-charged.

As shown in FIG. 2, when the second phase converting circuit SCC2 is in the standby mode, the controller CTL outputs a pulse width modulation signal PWM2 to the switches Q6 and Q8 of the second phase converting circuit SCC2 according to the phase control signal STEP, and the pulse width modulation signal PWM2 is at high-level at this time, so that the switches Q6 and Q8 are continuously conducted (the switches Q5 and Q7 are not conducted). In this way, the flying capacitor CFLY2 of the second phase converting circuit SCC2 can be coupled in parallel with the output capacitor COUT to charge the flying capacitor CFLY2, while maintaining the voltage across the flying capacitor CFLY2 as the output voltage, for example, half of the input voltage VIN.

As shown in FIG. 3, when the second phase converting circuit SCC2 is switched from the standby mode to the operating mode, the phase control signal STEP is at high-level, and the controller CTL provides the pulse width modulation signal PWM2 to the second phase converting circuit SCC2 according to the phase control signal STEP. Since the flying capacitor CFLY2 has been pre-charged, the voltage VCFLY2 across the flying capacitor CFLY2 equals to VOUT=½*VIN.

When the switches Q5 and Q7 are conducted, the flying capacitor CFLY2 is coupled in series with the output capacitor COUT. Due to the voltage VCFLY2 across the flying capacitor CFLY2 equals to VOUT=½*VIN, the voltage at the node N3 becomes VOUT+½*VIN=VIN; that is to say, the voltage across the switch Q5 coupled to the input voltage VIN is approximately zero, and the zero voltage switching (ZVS) of the switch Q5 can be achieved, so it can effectively avoid the inrush current when the second phase converting circuit SCC2 changes from the standby mode to the operating mode or the peak fluctuation of the output voltage VOUT.

It should be noted that although the multi-phase switched capacitor power converter 2 in the above-mentioned embodiment includes only two phase converting circuits, the multi-phase switched capacitor power converter of the invention can actually include a third phase converting circuit, even a fourth phase converting circuit, a fifth phase converting circuit, . . . and more phase converting circuits, and when the above-mentioned phase converting circuits are in the standby mode, the above-mentioned phase converting circuits will maintain the same operation as the second phase converting circuit SCC2, so it is not elaborated hereinafter.

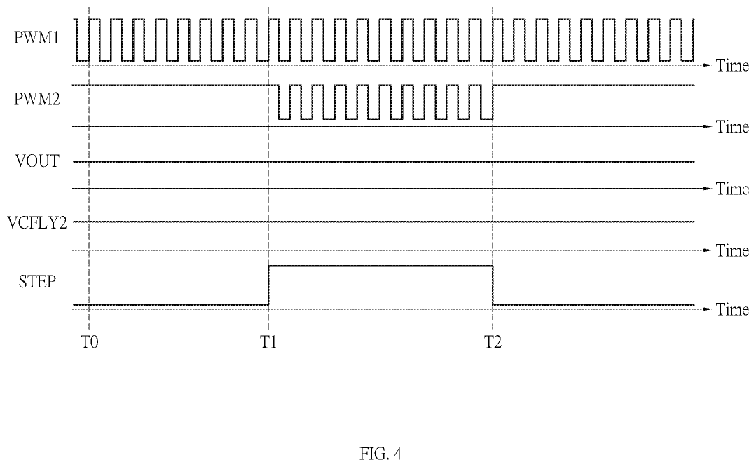

Please refer to FIG. 4. During the period from the time T0 to the time T1, the multi-phase switched capacitor power converter 2 is lightly-loaded, the second phase converting circuit SCC2 is in the standby mode, and the phase control signal STEP is at low-level to make the pulse width modulation signal PWM2 provided by the controller CTL at high-level, thereby controlling the switches Q6 and Q8 of the second phase converting circuit SCC2 to be continuously conducted, so that the flying capacitor CFLY2 of the second phase converting circuit SCC2 and the output capacitor COUT can be coupled in parallel to pre-charge the flying capacitor CFLY2.

At the time T1, the multi-phase switched capacitor power converter 2 changes from light-load to heavy-load, the second phase converting circuit SCC2 changes from the standby mode to the operating mode, and the phase control signal STEP changes from low-level to high-level, so that the pulse width modulation signal PWM2 provided by the controller CTL becomes a normal switching state.

During the period from the time T1 to the time T2, the multi-phase switched capacitor power converter 2 is maintained heavily-loaded, the second phase converting circuit SCC2 is maintained in the operating mode, the phase control signal STEP is maintained at high-level, and the pulse width modulation signal PWM2 is maintained the normal switching state to control the switches of the second phase converting circuit SCC2 to switch.

At the time T2, the multiphase switched capacitor power converter 2 changes from heavy-load to light-load again, the second phase converting circuit SCC2 changes from the operating mode to the standby mode, and the phase control signal STEP changes from high-level to low-level, So that the pulse width modulation signal PWM2 is maintained at high-level, thereby conducting the switches Q6 and Q8 of the second phase converting circuit SCC2, so that the flying capacitor CFLY2 of the second phase converting circuit SCC2 and the output capacitor COUT can be coupled in parallel to pre-charge the flying capacitor CFLY2.

Another preferred embodiment of the invention is a multi-phase switched capacitor power converter. In this embodiment, the multi-phase switched capacitor power converter includes a first phase converting circuit, a second phase converting circuit and a controller. The second phase converting circuit includes a plurality of switches and a flying capacitor. The switches are coupled in series and there are a first node and a second node between the switches. The flying capacitor is coupled to the first node and the second node. The controller is coupled to the first phase converting circuit and the switches of the second phase converting circuit respectively. when the controller controls the first phase converting circuit in an operating mode and controls the second phase converting circuit in a standby mode, the controller controls a part of the switches of the second phase converting circuit continuously conducted to charge the flying capacitor.

In practical applications, the switches can include a first switch, a second switch, a third switch and a fourth switch coupled in series, and the switches can be transistors, such as metal-oxide-semiconductor field-effect transistors (MOSFETs), but not limited to this.

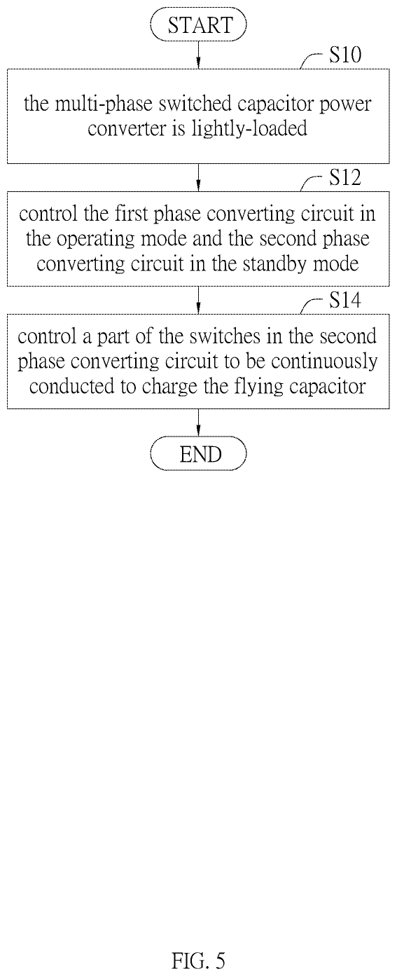

Please refer to FIG. 5. FIG. 5 illustrates a flowchart of the multi-phase switched capacitor power converter control method in this embodiment. As shown in FIG. 5, the control method includes following steps:

Step S10: the multi-phase switched capacitor power converter is lightly-loaded;

Step S12: controlling the first phase converting circuit in the operating mode and the second phase converting circuit in the standby mode; and

Step S14: controlling a part of the switches in the second phase converting circuit to be continuously conducted to charge the flying capacitor.

In practical applications, when the multi-phase switched capacitor power converter is heavily-loaded, the first phase converting circuit and the second phase converting circuit are both in the operating mode.

It should be noted that the multi-phase switched capacitor power converter of the invention can actually include more phase converting circuits, such as a third phase converting circuit, even a fourth phase converting circuit, a fifth phase converting circuit and when the above-mentioned phase converting circuits are in the standby mode, they also maintain the same operation as the second phase converting circuit, so it is not elaborated hereinafter.

Compared to the prior art, the multi-phase switched capacitor power converter and control method thereof in the invention can effectively avoid the inrush current appeared at the moment of phase conversion without causing the switch coupled to the input voltage to burn out and can maintain a stable output voltage without peak fluctuations to improve the performance of the multi-phase switched capacitor power converter.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A control method for a multi-phase switched capacitor power converter comprising a first phase converting circuit and a second phase converting circuit, the first phase converting circuit and the second phase converting circuit comprising a plurality of switches and a flying capacitor respectively, the switches being coupled in series and there being a first node and a second node between the switches, and the flying capacitor being coupled to the first node and the second node, the control method comprising:
when the first phase converting circuit is in an operating mode and the second phase converting circuit is in a standby mode, controlling a part of the switches of the second phase converting circuit continuously conducted to charge the flying capacitor.

2. The control method of claim 1, wherein the switches comprises a first switch, a second switch, a third switch and a fourth switch coupled in series; the first node is located between the first switch and the second switch and the second node is located between the third switch and the fourth switch; the second switch and the fourth switch are continuously conducted when the second phase converting circuit is in the standby mode.

3. The control method of claim 1, wherein when the multi-phase switched capacitor power converter is lightly-loaded, the first phase converting circuit is in the operating mode and the second phase converting circuit is in the standby mode.

4. The control method of claim 1, wherein when the multi-phase switched capacitor power converter is heavily-loaded, the first phase converting circuit and the second phase converting circuit are both in the operating mode.

5. A multi-phase switched capacitor power converter, comprising:
a first phase converting circuit;
a second phase converting circuit comprising a plurality of switches and a flying capacitor, wherein the switches are coupled in series and there are a first node and a second node between the switches, and the flying capacitor is coupled to the first node and the second node; and
a controller, coupled to the first phase converting circuit and the switches of the second phase converting circuit respectively,
wherein when the controller controls the first phase converting circuit in an operating mode and controls the second phase converting circuit in a standby mode, the controller controls a part of the switches of the second phase converting circuit continuously conducted to charge the flying capacitor.

6. The multi-phase switched capacitor power converter of claim 5, wherein the multi-phase switched capacitor power converter further comprises an output capacitor; when the second phase converting circuit is in the standby mode, the output capacitor and the flying capacitor are coupled in parallel.

7. The multi-phase switched capacitor power converter of claim 5, wherein the switches of the second phase converting circuit comprises a first switch, a second switch, a third switch and a fourth switch coupled in series; the first node is located between the first switch and the second switch and the second node is located between the third switch and the fourth switch.

8. The multi-phase switched capacitor power converter of claim 7, wherein the second switch and the fourth switch are continuously conducted when the second phase converting circuit is in the standby mode.

9. The multi-phase switched capacitor power converter of claim 5, wherein when the multi-phase switched capacitor power converter is lightly-loaded, the first phase converting circuit is in the operating mode and the second phase converting circuit is in the standby mode.

10. The multi-phase switched capacitor power converter of claim 5, wherein when the multi-phase switched capacitor power converter is heavily-loaded, the first phase converting circuit and the second phase converting circuit are both in the operating mode.
